(19) United States
(12) Patent Application Publication
(10) Pub. No.: US 2024/0417291 A1
(43) Pub. Date: Dec. 19, 2024

(54) Pretreatments to Contaminated Water Prior to Hydrothermal or Supercritical Water Oxidation Destruction of PFAS

(71) Applicant: Revive Environmental Technology, LLC, Columbus, OH (US)

(72) Inventors: Taylor Cochran, Columbus, OH (US); Samer AL-Dirani, Columbus, OH (US); Stephen H. Rosansky, Tampa, FL (US); Terrance Walsh, Columbus, OH (US); Kamanu Loo, Columbus, OH (US); Cristina Piekarz, Vallejo, CA (US)

(21) Appl. No.: 18/675,137

(22) Filed: May 27, 2024

Related U.S. Application Data
(60) Provisional application No. 63/504,736, filed on May 27, 2023.
(60) Provisional application No. 63/582,229, filed on Sep. 12, 2023.

(51) Int. Cl. C02F 1/66; C02F 1/02; C02F 1/44; C02F 1/52; C02F 1/72; C02F 101/12; C02F 101/36

(52) U.S. Cl. CPC C02F 1/66; C02F 1/02; C02F 1/441; C02F 1/5236; C02F 1/722; C02F 1/727; C02F 2101/12; C02F 2101/36; C02F 2209/02; C02F 2209/06; C02F 2209/44

(57) ABSTRACT

Perfluorinated alkyl substances (PFAS) or other contaminants are destroyed by an oxidation reaction under hydrothermal or supercritical conditions is improved by pretreatments such as the addition of acetic acid. Systems for destroying the contaminants are also described.

### RELATED APPLICATIONS

This application claims the priority benefit of U.S. Provisional Patent Application Ser. Nos. 63/504,736 filed 27 May 2023 and 63/582,229 filed 12 Sep. 2023.

### INTRODUCTION

Per- and polyfluoroalkyl substances (PFAS), commonly called “forever chemicals,” are a risk to human health and the environment. Although some PFAS compounds with known human health risks have been voluntarily phased out (PFOA and PFOS), legacy contamination remains. Replacement PFAS compounds have been introduced with limited understanding of their health risks. PFAS contamination in drinking water sources in 1,582 locations in 49 states as of May 2020. Currently used techniques for treating PFAS-contaminated water are expensive, and management of spent media is costly and may result in long-term liability.

The destruction of PFAS via Supercritical Water Oxidation (SCWO) has been described by Rosansky et al. in U.S. Pat. No. 11,407,666 which is incorporated herein as if reproduced in full below. The operating conditions of a SCWO continuous method and reactor (hereafter referred to as PFAS Annihilator™) have been developed and found to have several benefits for environmental remediation and waste management industries. The PFAS Annihilator™ consistently achieves near-complete destruction of PFAS, bringing the concentrations down to non-detect for most target PFAS, and consistently down to less than 70 ppt (parts per trillion) for all PFAS in under 30 seconds. This technology can be used to treat material contaminated with PFAS and other substances such as petroleum hydrocarbons or chlorinated solvents, which are also readily oxidized. Moreover, SCWO can be applied to a variety of PFAS-impacted liquids such as AFFF, landfill leachate, and investigation derived waste (IDW) due to its non-targeted carbon-fluorine bond destruction. The treated effluent is largely comprised of the products of complete combustion including carbon dioxide and water, and the corresponding anion acids; hence, the treated liquid can be released back into the environment after neutralization.

SCWO involves oxidation of aqueous organic compounds at temperatures and pressures above the critical point of water in the presence of oxygen. This technology has shown rapid and near-complete destruction of several recalcitrant organic contaminants including polychlorinated biphenyls, radioactive waste, and certain nerve agents. The SCWO process involves reacting the dissolved organic contaminant with an oxidant in water at a temperature and pressure above the supercritical point of water (374° C. and 3,205 pounds per square inch [psi]). At these conditions, the water and organics become miscible and form a uniform homogeneous mixture, which results in changes in their properties and provides a single fluid phase of a water-oxygen-organic mixture. The reaction of organic molecules with oxygen generates environmentally benign end products, such as water, carbon dioxide, and inorganic salts. A review of some recent demonstrations of supercritical water oxidation (SCWO) is provided by Kraus et al. in “Supercritical water oxidation as an innovative technology for PFAS destruction,” J. Environ. Eng. 148 (2022).

Water treatment systems that mineralize organic contaminants (such as PFAS, 1,4-dioxane, etc.) that operate at high temperatures (>212 deg F.) and pressures (>2,400 lb/in2) are prone to scale and corrosion that contribute to serious problems. Deposits (scale) can form on equipment such as heat exchangers, reactors, piping, safety devices, and other processing equipment. As the equilibrium conditions in the water change with temperature and pressure, contaminants will precipitate when their solubility limit has been exceeded. Typical scaling constituents are calcium, magnesium, and phosphate-based, but also include more aggressive, tenacious scales that are silica based. In some cases, deposits may accumulate in treatment systems to an extent that operation is no longer possible or that treatment system efficacy is reduced. At high temperatures/pressures, deposits are a serious problem and cause potential for equipment failure due to localized concentration of corrosive constituents (like chloride and sulfate) and poor heat transfer that can impact water treatment efficacy. Deposits that form on the processing side of a heat exchanger insulate the metal from the cooling effect of the water flow and can contribute to overheating and even piping failure.

Constituents that contribute to deposits and corrosion should be removed prior to a high temperature/pressure water treatment system with pretreatment. Water treatment processes that are used for boilers (high temperature/pressure equipment for steam generation) typically involve a filtration process such as ultra-filtration, reverse osmosis, etc. to obtain treated water for processing. This approach is not feasible for organic contaminant water treatment processes in that the organics end up concentrating in the reject of these filtration processes along with the scaling/corrosive constituents. The invention provides improved treatments to hydrothermal or supernatural water oxidation.

### SUMMARY OF THE INVENTION

A method is described that allows for the segregation of organic contaminants for complete destruction of organics and mineralization of PFAS in a high temperature/pressure process while also removing factors that contribute to scaling/corrosion through a chemical pretreatment process. The water supply contaminated with organics may include, but are not limited to, landfill leachate, industrial wastewater, foam fractionate, membrane concentrate, groundwater, municipal water and wastewater, etc.

The invention ideally works in combination with a hydrothermal oxidation (at temperatures of at least 200° C.) or oxidation under supercritical water conditions (SCWO). A preferred SCWO process is described by Rosansky et al. in U.S. Pat. No. 11,407,666 which is incorporated herein by reference as if reproduced in full below. The invention may include, but is not limited to, any of the features described in U.S. Pat. No. 11,407,666.

We have encountered problems from excess metal cations which bonded to free anions and created salts, resulting in plugging and corrosion. In some embodiments, the method removes the need for pretreatment processes of adding magnesium oxide and calcium hydroxide. In some preferred embodiments, the additive to ameliorate clogging does not contain one or any combination of alkali elements, alkaline earth elements, transition metals, and halides which are not added prior to the oxidation step.

In one aspect, the invention provides a method of purifying contaminated water, comprising: providing contaminated water comprising an organic contaminant and a soluble inorganic species; combining the contaminated water with an organic acid to form a treated water composition having a pH of 4.5 or less, preferably between 2 and 4.4; and, subsequently, subjecting the treated water composition to further treatment comprising a hydrothermal treatment or a SCWO treatment; wherein at least 90% of the organic contaminant is destroyed.

In another aspect, the invention provides a system comprising: a sedimentation tank comprising water composition having a pH between 2 and 5 and comprising an organic contaminant and an organic acid; a conduit connecting an outlet of the sedimentation tank to a hydrothermal or SCWO reactor; optionally, additional components disposed between the sedimentation tank and the hydrothermal or SCWO reactor.

In a further aspect, the invention provides a method of destroying a contaminant by SCWO, comprising: in a reaction vessel combining water comprising an organic contaminant and a scaling constituent with a precipitating agent that reacts with the scaling constituent to form a solid that precipitates out of solution to produce a precipitate and a first treated water solution; passing the precipitate and the first treated water solution into a clarifier; passing treated water from the clarifier into a SCWO reactor where the treated water is reacted with an oxidizer; optionally, treated water from the clarifier is passed into a neutralizer tank prior to passing into a SCWO reactor; transferring sludge from the clarifier to the reaction vessel and/or to an extraction vessel (e.g., reaction tank 2 in FIG. 3); in the extraction vessel, separating contaminant from solids and combining the extracted contaminant with the treated water prior to passing into the SCWO reactor (typically, the contaminant separated in the extraction vessel is in a liquid, usually in a water-containing solution and often mixed with an alcohol used to extract the sludge in the extraction vessel); and, optionally, adjusting the pH of the treated water prior to the step of passing into the SCWO reactor.

In another aspect, the invention provides a method of destroying a contaminant by SCWO, comprising: providing water comprising an organic contaminant and a scaling constituent; adding to the water a precipitating agent that reacts with the scaling constituent to form a solid that precipitates out of solution to produce a precipitate and a first treated water solution; separating the precipitate from the first treated water solution; and subjecting the first treated water solution to a step of SCWO.

In a still further aspect, the invention provides a system comprising a reaction tank, the reaction tank comprising water, contaminant such as PFAS, and a precipitate; wherein the reaction tank further comprises an outlet wherein the outlet is connected to an inlet of a first clarifier; wherein the first clarifier further comprises an outlet that is connected to an inlet of an extraction vessel and/or wherein the first clarifier further comprises an outlet that is connected to an inlet of the reaction tank for recirculation of solids from the first clarifier to the reaction tank; where the clarifier comprises a liquid outlet that is connected to a SCWO reactor; optionally comprising a neutralization tank disposed in a pathway disposed between the clarifier and the SCWO reactor; optionally wherein the second clarifier further comprises an outlet that is connected to an inlet of the reaction tank for recirculation of solids from the second clarifier to the reaction tank; wherein the second clarifier further comprises a liquid outlet that is connected to the neutralization tank or to a conduit that leads to the SCWO reactor.

In another aspect, the invention provides a method of destroying PFAS in a continuous fashion, comprising: at a first location, adding a flow of an organic acid to a stream of PFAS-containing water to form an aqueous solution of the organic acid and PFAS; passing the aqueous solution to a first heat exchanger in a system where the solution is heated to form a heated mixture; and, subsequently, additionally heating the heated mixture to supercritical conditions in a SCWO reactor in the system; wherein the average residence time of the fluid in the system, from the location of adding the flow of the organic acid to an inlet of the SCWO reactor is 3 minutes or less, preferably 1 minute or less, preferably 30 seconds or less.

Although the methods are described in reference to PFAS destruction, it can also be applied to destroying other compounds. Residence time can be measured by passing a tracer through the system. The organic acid can be added at a single point or at multiple points. In the case where multiple points are used, the average residence time is the mass average residence time. The method is superior to adding the organic acid to a tank prior to passage into the continuous system. The continuous system is enclosed, while adding the organic acid to PFAS-containing water in a tank generates a gas that removes PFAS into a gas phase that typically separates from the liquid water and does not get pumped into the system. Preferably, the method does not utilize reverse osmosis. Preferably, no fluoride salts (such as NaF) are added in the method.

In any of its aspects, the invention may be further characterized by one or any combination of the following: combining the contaminated water with an organic acid to form a treated water composition having a pH of 4.0 or less or 3.5 or less, or between 2.0 and 4.0; further comprising a step following the combining step of filtering a precipitate; comprising heating the treated water composition to a temperature of at least 50° C. or 50 to 90° C. or 70 to 80° C.; wherein the contaminated water comprises a carbonate species and the addition of organic acid causes the release of carbon dioxide from the carbonate species; wherein the water comprising an organic contaminant is subjected to reverse osmosis to increase the concentration of the organic contaminant; wherein the further treatment comprises SCWO with hydrogen peroxide or dioxygen; wherein the organic contaminant comprises PFAS; wherein the organic acid comprises 90 mass %, 95 mass %, or 99 mass % acetic acid; wherein the method does not add a metal, silica and/or an alkaline earth element; wherein the method does not add a precipitating agent; further comprising a step combining the contaminated water comprising an organic contaminant and a soluble inorganic species with a precipitating agent that reacts with the soluble inorganic species to form a solid that precipitates out of solution to produce a precipitate and a first treated water solution in a clarifier; combining treated water from the clarifier with the organic acid to form the treated water composition having a pH of 4.5 or less, preferably between 2 and 4.4; further comprising: extracting the organic contaminant from the precipitate and combining the extracted contaminant with the treated water prior to the hydrothermal treatment or SCWO treatment; wherein the soluble inorganic species comprise one or more of calcium, magnesium, phosphate, and silica; wherein the soluble inorganic species comprise calcium or magnesium or both calcium and magnesium; wherein the precipitating agent comprises lime, magnesium oxide, caustic (NaOH), aluminum sulfate, soda ash and/or sulfide precipitation reagents; further comprising a step of adjusting pH prior to the step of adding a precipitating agent; wherein the organic contaminant comprises PFAS and comprising: adding a flow of the organic acid to a stream of PFAS-containing water to form an aqueous solution of the organic acid and PFAS; wherein the average residence time of the fluid in the system, from the location of adding the flow of the organic acid to an inlet of the SCWO reactor is 3 minutes or less, preferably 1 minute or less, preferably 30 seconds or less; and wherein the PFAS is destroyed in the SCWO reactor in a continuous process; where the location is at or within 25 cm (or within 5 cm) of a pump that pushes the PFAS-containing water into a conduit that leads to a first heat exchanger in the system; wherein the organic acid is added at a volume/volume ratio with contaminated water of between 1/1000 and 1/50 or 1/1000 to 1/100 or at least 5/1000 or at least 10/1000; wherein the temperature of the water in the sedimentation tank is in the range of 50 to 90° C.; wherein the water composition comprises at least 1 ppm PFAS; wherein the contaminant comprises PFAS; wherein the scaling constituents (inorganic species) comprise calcium, magnesium, phosphate, and silica; wherein scaling constituents comprise calcium, magnesium, wherein pretreatment, prior to precipitating step, comprises filtration; wherein pretreatment, prior to precipitating step, comprises concentrating a solution to form the water comprising an organic contaminant and a scaling constituent; wherein the precipitating agent comprises lime, magnesium oxide, caustic (NaOH), aluminum sulfate, soda ash and/or sulfide precipitation reagents; further comprising a step of removing solids prior to the step of adding a precipitating agent, further comprising a step of removing solids from the first treated water solution; further comprising a step of adjusting pH prior to the step of adding a precipitating agent; further comprising a step of adjusting pH of the first treated water solution;
wherein the precipitating step occurs in a first vessel and further wherein at least a portion of the precipitate is transferred to a second vessel and wherein the precipitate in the second vessel is treated to remove organic contaminants, and/or wherein the removed organic contaminants are subjected to a step of SCWO; wherein, prior to passing into the SCWO reactor, passing the heated mixture into a salt separator where NaCl is removed from the heated mixture; where the first location is at or within 25 cm (or within 5 cm) of a pump that pushes the PFAS-containing water into a conduit that leads to a first heat exchanger; wherein the organic acid is added at a volume/volume ratio of between 1/1000 and 1/50 or 1/1000 to 1/100 or at least 5/1000 or at least 10/1000; wherein the method does not comprise a step of reverse osmosis; wherein the method is continuous, and/or wherein the organic acid is added in a continuous fashion such as drip addition to a stream.

Typically, the PFAS-containing water can be in a relatively large volume tank and is then pumped into a conduit such as a pipe. A system is sized to the amount and rate to suit the volume and rate of PFAS-contaminated water to be treated. Typically, the organic acid is added to the system in the form of an aqueous solution of at least 10% of the acid.

The invention also includes compositions, such as intermediate compositions, created by the methods described herein. The invention also includes apparatus as described here such as pretreatment tanks and/or a SCWO reactor. The invention further includes systems comprising both apparatus plus any of the compositions or conditions described herein. The system may comprise any of the conditions and/or fluids described herein. The invention also includes any of the intermediate compositions that occur during any of the methods described here.

One surprising result of the invention is that it significantly reduces clogging and solids build-up (scaling) in the piping of the destruction apparatus. The invention, in preferred embodiments, can be characterized by the appearance of at least 10 mass % less solid precipitates in the system than an identical method that does not include the addition of an organic acid.

Various aspects of the invention are described using the term “comprising;” however, in narrower embodiments, the invention may alternatively be described using the terms “consisting essentially of” or, more narrowly, “consisting of.” All ranges are inclusive and combinable. For example, when a range of “1 to 5′ is recited, the recited range should be construed as including ranges “1 to 4”, “1 to 3”, “1-2”, “1-2 & 4-5”, “1-3 & 5”, “2-5”, any of 1, 2, 3, 4, or 5 individually, and the like.

### Glossary

A “clarifier” is alternatively called a clarifier tank and is a known type of vessel in which solids are separated from a liquid.

Hydrothermal oxidation reactions are conducted at a temperature of at least 200° C., or at least 220° C., or at least 250° C., or at least 300° C. so that the materials are in contact for at least 10 seconds or at least 30 seconds or at least 1 minute or at least 10 minutes or at least 30 minutes, or in the range of 10 seconds to one hour.

An “organic acid” is an organic compound with acidic properties. Organic acids have carboxylic moieties and are typically low molecular weight with acetic acid being especially preferred for removal of Ca and Mg. In some preferred embodiments, the organic acid has a pKa between 3.0 and 6.0, more preferably between 3.5 and 5.5. Organic acids are preferably carboxylic acids; examples include: formic acid, acetic acid, propionic acid, lactic acid, gluconic acid, and citric acid. A preferred acid is acetic acid.

Per- and polyfluoroalkyl substances (PFAS), including perfluorooctane sulfonate (PFOS) and perfluorooctanoic acid (PFOA), and hundreds of other similar compounds, have been widely used in the United States in a multitude of applications. There are significant concerns associated with these compounds due to widespread contamination coupled with uncertainties about risks to human health and the environment. PFAS are molecules having chains of carbon atoms surrounded by fluorine atoms. The C—F bond is very stable enabling the compounds to persist in the natural environment. Some PFAS include hydrogen, oxygen, sulfur, phosphorus, and/or nitrogen atoms. One example is PFOS:

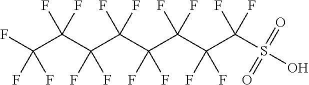 [SMILES: O=S(=O)(O)C(F)(F)C(F)(F)C(F)(F)C(F)(F)C(F)(F)C(F)(F)C(F)(F)C(F)(F)F]

According to the present invention, PFAS-contaminated water has the conventional meaning. The source of the PFAS-contaminated water can be from soil or surface or underground water in areas subjected to PFAS contamination. These areas can be industrial areas, especially where water-proofing or non-stick coatings have been applied. Another common source of PFAS-contaminated water is in areas around airfields or firefighting training areas that have been exposed to AFFF (aqueous film forming foam). Another source can be storage vessels, typically these are accumulated for future destruction or disposal. Typically, there will be non-fluorinated organic compounds present in PFAS-contaminated water and, especially in AFFF residue, there can be chlorinated or brominated compounds.

Precipitation reagents may include known reagents for precipitating solids from water. Nonlimiting examples of precipitating agents include lime (CaO), magnesium oxide (MgO), NaOH, soda ash (sodium and/or potassium carbonate), aluminum sulfate (Al₂(SO₄)₃). Examples of counterions in precipitating agent may include, but are not limited to, sulfide (S²⁻), hydroxide (OH⁻), carbonate (CO₃²⁻), and phosphate (PO₄³⁻).

A system includes apparatus, materials within the apparatus, and, optionally, conditions within the apparatus.

### BRIEF DESCRIPTION OF THE DRAWINGS

FIG. 1 shows a flow diagram for a pretreatment involving precipitation followed by acidification.

FIG. 2 shows a flow diagram for a pretreatment process without addition of a precipitation agent.

FIG. 3 shows a flow diagram for a pretreatment process for precipitation and recovery of contaminants from precipitate.

FIG. 4 is a schematic illustration of a water pretreatment system for treating PFAS-contaminated water prior to passage through a SCWO reactor.

### DESCRIPTION OF THE INVENTION

Initially, water or soil samples may be treated to concentrate PFAS in a substantially reduced volume. In some instances, the PFAS-containing media has been stored in a concentrated form and does not require additional treatment to concentrate it. The concentrated PFAS mixtures can be put in containers and shipped to a centralized site for PFAS destruction. Alternatively, in some preferred embodiments, the concentrated PFAS mixtures are treated on-site where they originate.

The concentrated PFAS solution can be destroyed by Supercritical Water Oxidation (SCWO), which can rapidly result in over 100,000 times reduction in PFAS concentration, for example, a reduction in PFOA from 1700 parts per million (ppm) to 5 parts per trillion (ppt) by weight or less. To enable efficient destruction with little or no external heat supply during steady state operation, fuels may be added (or, in some occurrences, PFAS may be present with sufficient organic materials that serve as the fuel) to supply some or all of the heat needed to power the oxidation. The resulting effluent can then be confirmed to contain little or no PFAS, typically 5 ppt or less, and then be released back into the environment as safe, clean water.

PFAS-contaminated water can be concentrated by known means. For example, passing PFAS-contaminated water into a tank, wherein the water is super-saturated with air; wherein pressure in the tank is relatively low such that bubbles are generated in the water and create a foamed mixture; and collecting the foamed mixture. The use of dissolved air floatation (DAF) facilitates removal of PFAS. The principle of DAF is to produce micro-bubbles (appearing as cloudy water) inside a treatment cell by first creating what is known as white water, which is pressurized water (typically to pressures of approximately 75 pounds per square inch gauge [psig]) that is saturated with air (nitrogen and oxygen). Once the white water enters an atmospheric pressure environment, the water becomes supersaturated with air and thus the air drops out of solution creating micro-bubbles. Unlike bubbling air into a tank, these bubbles would be so fine that they would essentially occupy the entire floatation chamber and would rise very slowly allowing much greater contact between air and PFAS than what could be achieved via aeration/air sparging. In addition, a very low volume of air would be introduced into the cell in comparison to what would be injected in a sparging application. This allows the PFAS to be “scrubbed” and gently floated to the top of the chamber.

### Pretreatment

Debris and other solids can be removed from the PFAS-contaminated water prior destruction of the PFAS. Typically, this can be accomplished by one or a plurality of filtration steps. In some embodiments, a plurality of filtration steps can be conducted in which increasingly smaller particles are removed. The filters can be valved so that only one or a series of filters can be utilized; for example one filter or a set of filters can be cleaned or exchanged while another filter or set of filters continue to operate. Filters can be any type of filter known for filtering water such as bag filters, cartridge filters, metal screen or sand (preferably silica sand). Alternatively, or in addition, centrifugal separation can be used to remove solids.

The PFAS-contaminated water can be subjected to a softening treatment to remove undesired counterions (typically Ca and Mg) because these foul a RO membrane. These softening treatments may include one or any combination of the following: ion exchange resin, lime softening (aqueous calcium hydroxide to precipitate solids); chelating agents (for example, treatment with EDTA or the like); and reverse osmosis. In any pretreatment, capture of PFAS in pretreatment media should be considered. Alternatively, or in addition, compounds such as organics can be removed by passage through hydrophobic clay to remove separated and/or emulsified hydrocarbons.

An optional treatment according to less preferred methods of the invention is reverse osmosis. Reverse osmosis (RO) systems can remove or concentrate PFAS from water streams. PFAS-free (or PFAS-reduced) water travels through the membrane while the PFAS and salts are directed to a brine stream. Efficiency of PFAS removal and throughput is increased by implementing a cascade of RO membranes. In some embodiments, RO is utilized to increase the concentration of PFAS by at least 5 times or at least 10 times, and in some embodiments in the range of 5 to 30 times or 5 to 20 times, or 10 to 40 times. In some preferred embodiments, the influent to RO preferably has a total dissolved solids to 1200 ppm or less; however, other systems comprising larger pumps and tighter wound membranes can handle much higher TDS and achieve effective concentration in accordance with the present invention, chlorine levels of 0.5 ppm or less more preferably 0.1 ppm or less, pH between 1 and 12, more preferably between 2 and 11, the substantial absence of oil or grease, very low levels of Ba and Si (if present initially, these can be removed in a water softening step); a flowrate depending on the scale required, in some embodiments, the RO will be conducted in a range of about 3 to 5 gallons (11 L to 19 L) per minute. The retentate typically comprises an aqueous solution having a PFAS concentration that is 10×, 100×, 1000×, 10,000× or more as compared to the PFAS contaminated water entering the system.

In a preferred PFAS destruction process only 10%, or only 1%, or only 0.1%, or only 0.01% or less of the water in the PFAS contaminated water is heated to SCWO conditions.

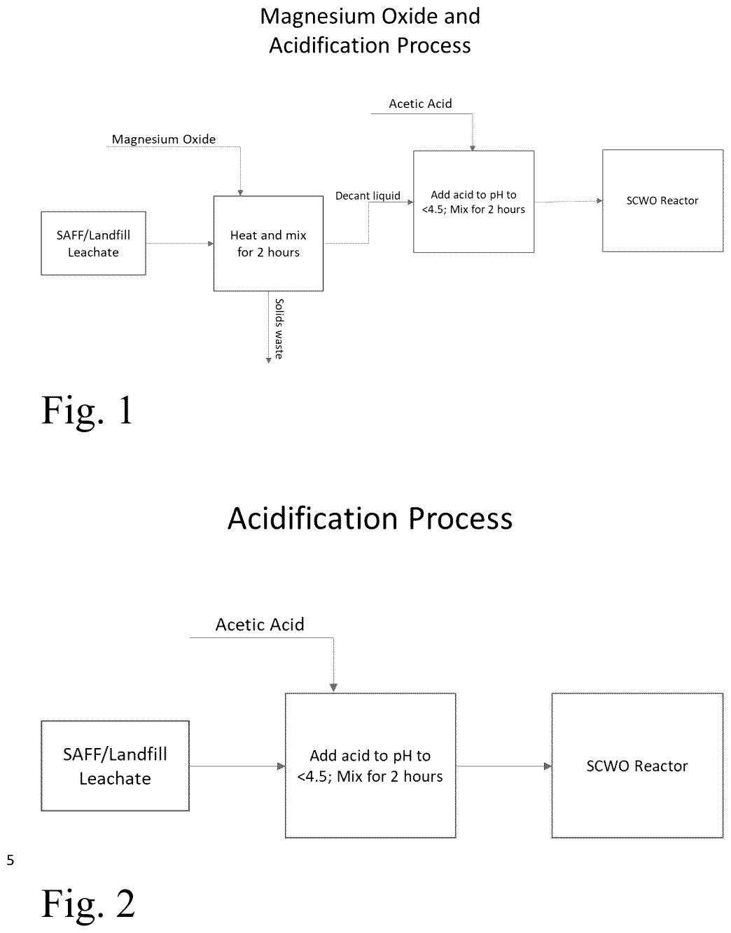

FIG. 1 illustrates a two-step pretreatment process: In a first step, a precipitating agent such as magnesium oxide is added to a PFAS-containing aqueous composition such as landfill leachate. Optionally, the solution is heated to increase the rate of precipitation. Solids are removed, for example, in a settling tank. The decanted liquid is treated with an organic acid, preferably concentrated acetic acid, the treated solution is mixed to obtain a pH of 4.5 or less.

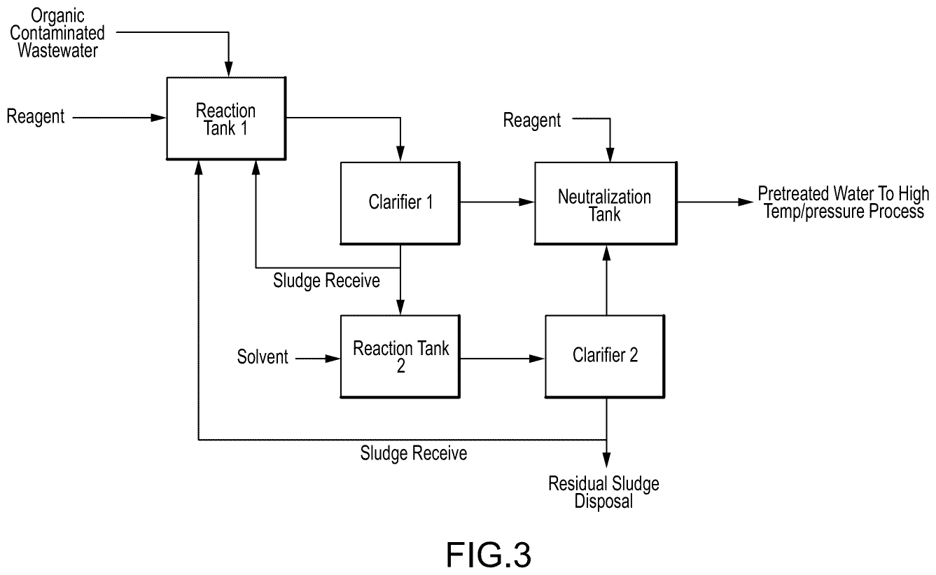

FIG. 2 illustrates a pretreatment process without addition of a precipitation agent. In either case, with or without a precipitation step, the acidified solution is then passed to a SCWO Reactor. Typically, additional steps such as preheating, are conducted prior to entry into the SCWO reactor. Optionally, a step of salt separation can be used at any stage of the process. In a preferred process, the acidified solution is fed to the SCWO reactor without a step of salt separation and/or without any steps between the acidification and the SCWO reactor other than preheating and optionally addition of an oxidant prior to, or within, the SCWO reactor and/or removing CO2 vapor.

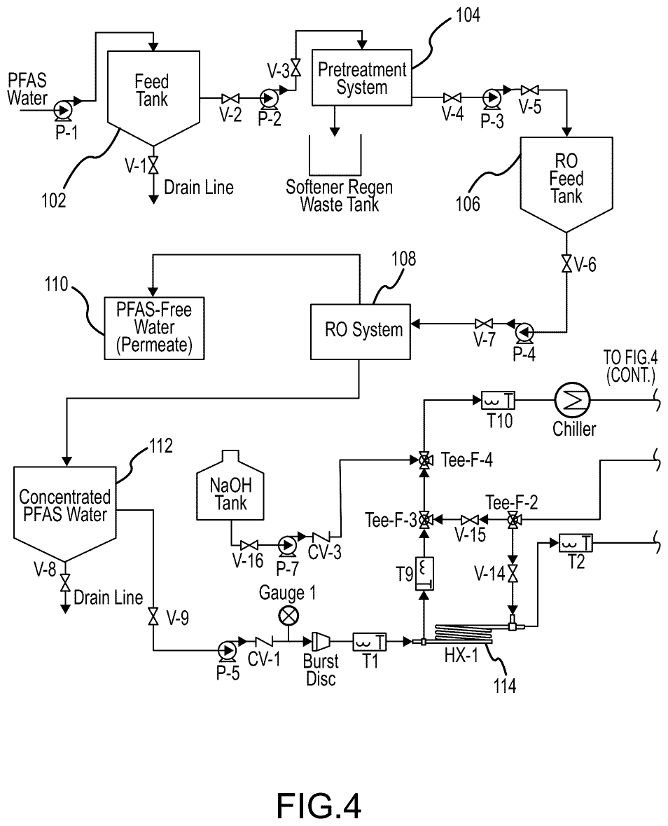

Another pretreatment method is provided in FIG. 3. The process involves introducing the water supply contaminated with organics (such as landfill leachate, industrial wastewater, foam fractionate, membrane concentrate, groundwater, municipal water and wastewater, etc.) with a reagent to facilitate the removal of constituents that would otherwise contribute to scaling/corrosion in the high temperature/pressure water treatment system at temperatures up to 212° F. (100° C.). Reagents used for the precipitation of constituents can include, but are not limited to, lime, magnesium oxide, caustic (NaOH), aluminum sulfate, soda ash, sulfide precipitation reagents, and others.

An initial step of a process involves mixing the organic contaminated water with reagent into a reaction tank for adequate residence time and temperature, and then transferring to a clarifier/settling tank. The clarified effluent overflows to a neutralization tank for pH adjustment (if necessary) and then to the high temperature/pressure water treatment process, and the clarifier sludge is both recirculated back to the reaction tank, while also being blown-down to a second reaction tank for a solvent extraction of organic contaminants (if necessary). A solvent for the optional solvent extraction may include IPA, ethanol, methanol, or other alcohol-based reagents. The mixture from second reaction tank is then fed to another clarifier/settling tank. The overflow from this tank is sent to the neutralization tank as well, while the sludge is recirculated back to reaction tank 1, or properly handled for disposal. The process may be completed on a batch or continuous scale.

A process was implemented at scale for a supercritical water oxidation system for the treatment of PFAS in highly contaminated landfill leachate concentrated with foam fractionation. The pretreatment system removed all silica, metals, alkalinity, and other constituents contributing to scaling/corrosion—extending system run-time and increasing process efficacy. The sequence and reagent selection of chemical precipitation treatment depends on the type and concentration of contaminants in the water supply and is adjusted based on the type of organic contaminated water. A schematic diagram of a process flow of the invention is shown in FIG. 3.

PFAS Concentration from Water using Vacuum Air Flotation (VAF) and Vacuum Enhanced Cyclone Separation (VECS)

Given the surfactant properties of PFAS, they partition at the air-liquid interface and tend to concentrate at the air—water interfaces of the surface water bodies. Wave action introduces the air bubbles and results in the formation of foam. Laboratory research has demonstrated that bubbling air through PFAS-contaminated water can achieve removal of PFAS (Meng et al., Chemosphere (2018), “Efficient removal of perfluorooctane sulfonate from aqueous film-forming foam solution by aeration-foam collection.”). Dickson in US 2014/0190896 discusses the use of vigorously mixed ozone to treat industrial waste; lighter foam produced in the process is directed by a foam concentrator into a fractionate chamber. Prior art processes have issues associated with large amounts of air bubbled through the water creating large amounts of foam that is difficult to manage as well as concerns over aerosols being emitted.

In some aspects of the present invention, the combination of VAF and VECS optimizes the removal and overcomes the issues described above. The principle of VAF is to produce micro-bubbles (appearing as cloudy water) inside a treatment cell by injecting air (nitrogen and oxygen)-saturated water into the bottom of the cell that is maintained under high vacuum conditions. Once the air-saturated water enters the low-pressure environment, the water becomes supersaturated with air and thus the air would drop out of solution creating micro-bubbles. Unlike bubbling air into a tank, these bubbles would be so fine that they would essentially occupy the entire floatation chamber and would rise very slowly allowing much greater contact between air and PFAS than what could be achieved via air sparging. In addition, a very low volume of air would be introduced into the cell in comparison to what would be injected in a sparging application. This allows the PFAS to be “scrubbed” and gently floated to the top of the chamber. The treatment cell preferably has several floatation cells in series separated by baffles. The forward flow would flow via gravity from one floatation chamber to the next. The use of in-series chambers would enhance treatment efficiency. For example, if each cell achieved 75% removal of PFAS, having three chambers in series would achieve 98% removal and four cells would achieve greater than 99.5% removal.

The air-saturated water can be generated in a simple vessel where air is bubbled through water. The water is preferably drawn from an uncontaminated source, possibly treated effluent. The air-saturated water would be drawn into the floatation chambers, as those chambers are under a vacuum, thus no pumping is needed for this water.

### Preheating

PFAS-containing water is preferably heated prior (typically immediately prior) to entering a SCWO reactor. Heat from the reactor can used to heat water entering the reactor. The use of a heat exchanger makes the process more energy efficient, compact and extends service life of the reactor. A tube-in-tube heat exchanger is especially desirable.

### Supercritical Water Oxidation (SCWO)

PFAS-containing water is preferably heated prior (typically immediately prior) to entering the reactor. Heat from the reactor is used to heat water entering the reactor. The use of a heat exchanger makes the process more energy efficient, compact and extends service life of the reactor. A tube-in-tube heat exchanger is especially desirable. PFAS are destroyed and converted to carbonates, fluoride salts and sulfates. The device can be designed for 1) stationary applications or 2) transportation to a site. The stationary configuration can be employed at a permanent processing plant such as in a permanently installed water facility such as city water treatment systems. The portable units can be used in areas of low loading requirement where temporary structures are adequate. A portable unit is sized to be transported by a semi-truck or smaller enclosed space such as a trailer or shipping container. The design is adaptable to processing other organic contaminants by modifying operational parameters but without modification of the device.

A preferred SCWO reactor design is a continuous or semi-continuous system in which the (typically pre-treated) PFAS-containing aqueous solution is passed into a SCWO reactor. Because solids may form in the SCWO reactor, it is desirable for the reactor to slope downward so that solids are pulled by gravity downward and out of the reactor. In some embodiments, the flow path is straight and vertical (0°) with respect to gravity; in some embodiments, the reactor is sloped with respect to gravity, for example in the range of 5 to 70° (from vertical) or 10 to 50° or 10 to 30° or 10 to 200 and can have a bend so that flow moves in a reverse direction to provide a compact device in which flow is consistently downward with respect to gravity. Preferably, the reactor vessel is a cylindrical pipe formed of a corrosion resistant material. Desirably, the pipe has an internal diameter of at least 1 cm, preferably at least 2 cm and in some embodiments up to about 5 cm.

Flow through the components of the SCWO apparatus at supercritical conditions can be conducted under turbulent flow (Re of at least 2000, preferably in the range of 2500 to 6000). Effluent from the SCWO reactor can flow into a salt separator under supercritical conditions.

The SCWO system operates by raising the feed temperature and raising the feed pressure. The increased pressure can be due solely due to the heating (which is preferable) or can be further increased via a compressor or a high pressure (reciprocating) pump. The temperature is increased by: application of heat through the conduit (in the case of a continuous reactor) or through the reaction chamber in the case of a batch reactor, and/or by the addition of fuels such as alcohols or hydrocarbons that will be oxidized to generate heat in solution. Supercritical conditions are maintained for the oxidation; conditions within the reaction conduit or reaction chamber are preferably in the range of 374° C.-700° C. and at least 220 bar, more preferably 221-300 bar. In some embodiments, temperature in the SCWO reactor is maintained at 500° C. or more, or 600° C. or more and in the range of 500 to 650° C., or 600 to 675° C. The SCWO reactor is typically made of a high temperature resistive alloy. These alloys are useful for corrosion resistance at high temperature. In some preferred embodiments, the alloy comprises at least 50 wt % Ni and at least 5 wt % Cr. Suitable high temperature alloys are known in the SCWO art; one typical nickel-based alloy is Hastealloy® C-276.

Per- and Polyfluoroalkyl Substances (PFAS) are destroyed and converted to carbonates, fluoride salts and sulfates. The destruction or conversion of PFAS is achieved by the synergistic effect of temperature, pressure, addition of water, an oxidant and, optionally, an alkali or alkaline earth element (or mixtures thereof). The optional alkali or alkaline earth element may be added in the feed into the reactor or, preferably, into the effluent to remove HF. A quench at the very end of the oxidation process may be added to remove HF to form NaF or CaF₂ (for example). This process is essentially combustion of the organic molecules in water minus the 1) flame and 2) associated environmental contaminants that are harmful to the environment. The most notable products of the oxidation reaction are carbon dioxide and water, which are environmentally friendly. A fluoride (such as CaF2) can be removed from the water and separated for further processing if needed. The process water can be reused for the system.

### Oxidants

Typical feedstocks of reactant oxygen used in supercritical water oxidation for destruction of PFAS are oxygen gas (O₂) and hydrogen peroxide (H₂O₂). In addition to, or alternative to, these two chemical species, other reactant oxygen sources or oxidizing agents could be added to destroy PFAS in the oxidation reactor. Other oxidants are oxyanion species and peroxy acids. These include, but are not limited to, ferrate salts (FeO₄²⁻), percarbonate salts (ex. C₂K₂O₆), permanganate salts (ex. KMnO₄), potassium peroxymonosulfate (commercially known as Oxone), peroxybenzoic acid, and ozone (O₃).

Oxyanion species are a category of chemicals that includes, but is not limited to, ferrate (FeO₄²⁻), percarbonate (CO₄²⁻), permanganate (ex. MnO₄⁻), and Oxone. The general trend of these species is that at above ambient environmental conditions, the rate of oxygen release increases. The inventive system can operate at an elevated temperature and pressure to achieve supercritical water conditions. Under these same conditions, oxyanion species readily decompose and release their oxygen. Therefore, oxyanion species have the potential to be incorporated as a source of reactant oxygen; however, the addition of elements such as Mn introduces the possibility of formation of additional solids that can plug the reactor.

Peroxybenzoic and other peroxy acids are generally regarded as oxidizing agents. Historically they are predominantly used to oxidize alkenes to epoxides, Baeyer-Villiger oxidation of ketones to ester and lactones, and oxidation of heteroatoms to oxides (amines to amine oxides, sulfides to sulfoxides and sulfones, selenides to selenoxides, phosphine to phosphine oxides). In the present invention, a peroxy acid has the potential to be an oxidizing agent for PFAS destruction.

Ozone is unstable in neutral water solution and typically decomposes into O₂ and another species. In this way, ozone has the potential to be the source of reactant oxygen for the inventive processes.

The preferred oxidant is hydrogen peroxide which can be added in excess (for example an excess of at least 50% or at least 100% or in the range of 50% to 300% excess) and the excess hydrogen peroxide reacting to form dioxygen and water.

### Fuels

Fuel can be added to oxidize and generate heat for the SCWO reactor. The addition of fuel operates at any selected scale and flow rate. For example, if 100 gallons of PFAS contaminated water is treated with 2.54 gallons of isopropyl alcohol (density=0.785 g/mL), then if you have 100k gallons, it can be treated with 2540 gallons of IPA. Alternatively, the quantity of fuel can be calculated based on the heat required; for example, oxidation of IPA produces 1912 kJ/mol, IPA has a molecular weight of 60.1 g/mol, then if ˜20 mg/mL of PFAS water is needed, then 0.64 kJ/mL of PFAS solution is required.

At start up, the SCWO apparatus requires heating such as by external flame or resistive heating. Unless the reactive solution comprises high concentrations of PFAS or other organics, external heating is also needed during operation. As an alternative, or in addition to external heating of the SCWO apparatus, heat can be provided by the oxidation of fuels such as alcohols. Preferred fuels include methanol, ethanol, propanol (typically isopropanol), or combinations of these. The glycol ether may also be the sole or a co-fuel. Preferably, sufficient fuel is added so that external heating is unnecessary at steady-state conditions.

### Post Treatment

Leaving the SCWO reactor, the resulting clean water fraction can optionally be passed through adsorbent media such as activated carbon or ion exchange resin and returned to the environment. As with any of the aspects described herein, any of the pretreatment methods may be used by itself or in combination with any of the other aspects or other techniques described herein.

The corrosive effluent from the SCWO reactor containing aqueous HF at high temperature (for example, around 600° C.) can flow into a mixing pipe. Cooling water, typically containing hydroxy salts, can be fed into a mixing pipe where it mixes with the corrosive effluent. The cooled effluent contains dissolved fluoride salts such as NaF.

Since the SCWO process destroys essentially all of the PFAS, the treated effluent can be safely released back into the environment. In some embodiments, at least a portion of the effluent is evaporated into the air. Precipitates such as fluoride salts can be filtered or centrifuged from the effluent. PFAS-free effluent can be passed through a heat exchanger where the effluent is cooled by the PFAS-contaminated water flowing into the reactor. If necessary, the effluent may be subjected to treatments such as reverse osmosis and/or other treatments (ion exchange resins or other adsorptive media) to remove metals or other contaminants prior to release or disposal of the effluent.

### Additional Conditions

Any of the inventive processes can be characterized by one or any combination of the following. In some preferred embodiments a PFAS-containing solution is mixed with a solution comprising 30 to 50 wt % H₂O₂ at a weight ratio of preferably 30:1 to 70:1 wt % ratio or in a particularly preferred embodiment approximately 50:1 PFAS solution:H₂O₂. In some embodiments, the PFAS-containing solution is passed through a SCWO reactor with a residence time of 20 sec or less, preferably 10 sec, or 5 sec or less, or 0.5 to 5 seconds. In reactors in which the PFAS is destroyed in supercritical conditions, the reactor volume is based on the volume comprising supercritical fluid conditions. A preferred reactor configuration is a continuous plug flow reactor. In some tests, the feed of concentrated PFAS is passed into an oxidation reactor a rate of about 50 mL/min; in some embodiments rate is controlled between 50 and 150 mL/min (at STP); this rate can be adjusted to obtain the desired conditions. The feed can include fuel and oxidant. Preferably, no external heating is required after start-up. In some embodiments, the PFAS-containing aqueous mixture (preferably after a concentration pretreatment) comprises at least 100 ppm PFOA and the method decreases the PFOA concentration by at least 10⁶ or 10⁷ or 10⁸, and in some embodiments up to about 10⁹.

Any of the inventive aspects may be further defined by one or any combination of the following: wherein the method is carried out in a mobile trailer; the PFAS-containing aqueous mixture comprises at least 100 ppm PFAS and the method decreases the PFAS concentration by at least 10⁶ or 10⁷ or 10⁸; wherein the PFAS is reacted with oxidant in an oxidation reactor and after leaving the reactor the effluent is treated with a solution comprising NaOH, LiOH, or KOH to produce a neutralized solution that can be discharged or recycled to neutralize additional effluent; wherein the neutralized effluent is at least partially evaporated into the air; wherein by taking a PFAS-concentration wherein the PFAS-containing aqueous mixture comprises at least 100 ppm PFAS by weight (in some embodiments at least 500 ppm or at least 1000 ppm PFAS) that the method converts to an effluent comprising 1 ppm or less, or 0.1 ppm or less, or 0.01 ppm or less, or 1.0 ppb or less, or 0.1 ppb or less, or 0.01 ppb or less PFAS; in some embodiments in the range of 1 ppm to 5 ppt (part per trillion) PFAS or less; wherein the PFAS-containing solution is mixed with a solution comprising 30 to 50 wt % H₂O₂ at a weight ratio of preferably 30:1 to 70:1 wt % ratio PFAS solution:H₂O₂; wherein the PFAS-containing solution is passed through a SCWO reactor with a residence time of 20 sec or less, preferably 10 sec, or 5 sec or less, or 0.5 to 5 seconds; wherein the PFAS-containing solution is added at a rate controlled between 50 and 150 mL/min (at STP); wherein no external heating is required after start-up; wherein the PFAS-containing aqueous mixture comprises at least 100 ppm PFOA and the method decreases the PFOA concentration by at least 10⁶ or 10⁷ or 10⁸, and in some embodiments up to about 10⁹; wherein the method is conducted in a mobile trailer; wherein the method is conducted in a mobile trailer at a PFAS-contaminated site.

Any of the inventive methods may be further defined by, in the overall process, or the SCWO portion of the process, can be characterized by converting a PFAS-concentration of at least 100 ppb PFAS by weight (in some embodiments at least 500 ppb or at least 1000 ppb PFAS) to 1 ppb or less, or 0.1 ppb or less, or 0.01 ppm or less or 7 ppt or less. Alternatively, by converting a PFOA-concentration of at least 100 ppb PFOA by weight (in some embodiments at least 500 ppb or at least 1000 ppb PFOA) to 1 ppb or less, or 0.1 ppb or less, or 0.01 ppb or less, or 5.0 ppt or less PFOA; in some embodiments in the range of 1 ppm to 5 ppt (part per trillion) PFOA. Alternatively, by converting a PFOS-concentration of at least 100 ppb PFOS by weight (in some embodiments at least 500 ppb or at least 1000 ppb PFOS) to 1 ppb or less, or 0.1 ppb or less, or 0.01 ppb or less, or 5.0 ppt or less PFOS; in some embodiments in the range of 1 ppm to 5 ppt (part per trillion) PFOS. The process can also be characterized by the same levels of destruction beginning with a PFAS concentration of 1 ppm or more. In some embodiments, PFAS-contaminated water comprising at least 1000 ppt of at least one (or at least 3 or at least 4 or at least 5 or at least 6) compound selected from the group consisting of PFHxA (perfluorohexanoic acid), PFHpA (perfluoroheptanoic acid), PFOA, PFBS (perfluorobutane sulfonate), PFHxS (perfluorohexane sulfonate), PFHpS (perfluoroheptane sulfonate), and PFOS and combinations thereof, treated by the process is (are) reduced by at least 2 (or at least 3 or at least 4 or at least 5) orders of magnitude. In some embodiments, PFAS-contaminated water comprising at least 100 ppt of at least one (or at least 3 or at least 4 or at least 5 or at least 6) compound selected from the group consisting of PFBA (perfluorobutanoic acid), PFPeA (perfluoropentanoic acid), PFHxA, PFHpA, PFOA, 6:2 FTS (6:2 fluorotelomer sulfonate), and 8:2 FTS (8:2 fluorotelomer sulfonate) and combinations thereof, treated by the process is (are) reduced by at least 2 (or at least 3 or at least 4 or at least 5) orders of magnitude and/or reduced to 5 ppt (or 1 ppt) or less.

Any of these conditions may be utilized or obtained in a mobile unit.

### Mobile Units

One example of a mobile unit can be transported (and preferably operated within) a trailer. For example, the system can be transported (and optionally operated) on a trailer having dimensions of 29 feet (8.8 m) in length or less, 8 ft 6 in (2.6 m) or less width, and 13 ft 6 in (4.1 m) height or less. These dimensions define preferred size of a mobile system, although workers in this area will understand that other dimensions could be utilized in a mobile unit.

### Illustrated System

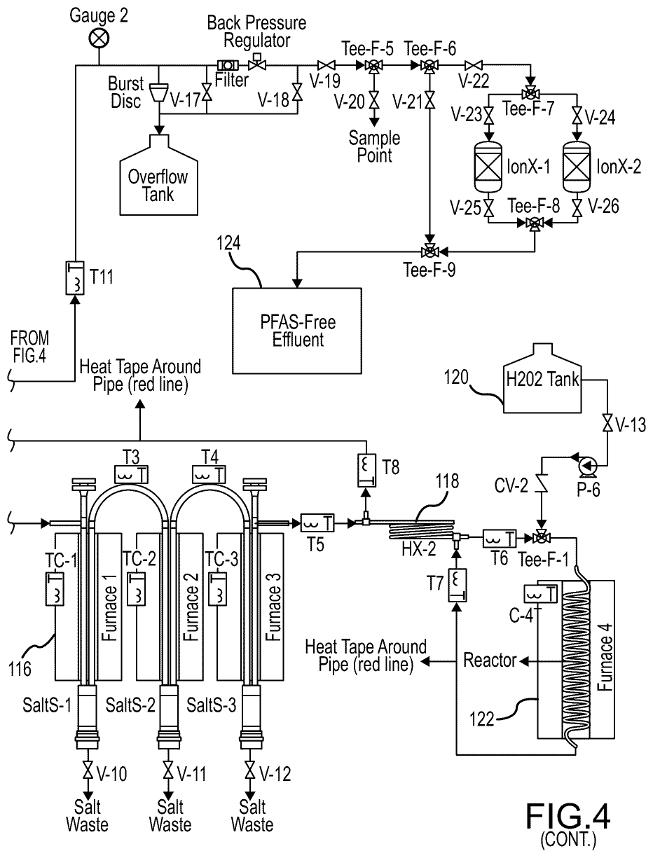

One embodiment of a system for PFAS destruction is schematically illustrated in FIG. 4. PFAS contaminated water entering the system can be subjected to numerous optional pretreatments including one of more of: filtration (not shown) storage in tank 102, a water softening pretreatment 104, a feed tank 106 connected to a reverse osmosis system 108. Water softening to replace other cations with sodium cations can be conducted by conventional means such as passage through an ion exchange resin. The reverse osmosis treatment (described above) produces a permeate 100 having PFAS concentrations that are reduced 10×, 100×, 1000×, 10,000× or more as compared to the PFAS contaminated water entering the system. In some cases, especially with relatively concentrated PFAS solution entering the system, the permeate can be subjected to additional RO treatment to bring the PFAS levels in the permeate down to a low level, such as below 70 ppt, where the water can be released to the environment; the retentate from the additional treatments can be combined with the concentrated solution or combined with incoming PFAS contaminated water such as in tank 102.

The concentrated PFAS water 112 can be passed through optional heat exchanger 114 which can be a tube-in-tube heat exchanger. The concentrated PFAS water 112 passes into salt separator 116. The salt separator can have a plurality of zones that operate at different conditions of temperature or pressure. The tubes can be heated by a tube furnace that surrounds the tubes. In the case of a plurality of vertical tubes (six shown in FIG. 4, three upward and three downward) can have a relatively large inner diameter—for example, at least 1.5 cm or at least 2.0 cm or at least 1 inch (2.4 cm)—to prevent plugging. At the bottom (with respect to gravity) of each salt separator tube is a larger diameter container (collector vessel 220), preferably having an inner diameter of at least 5 cm, or at least 10 cm, or in the range of 5 to 20 cm. Preferably the collection vessel includes a diameter that is at least two times or at least four times larger than the inlet tube. The collection vessel can be heated; for example by electrical tape. The collector vessel(s) connect the inlet and outlet, preferably have a depth of at least 20 cm, or at least 30 cm, or at least 40 cm, and in some embodiments in the range of 25 to 75 cm. Salt forming in the inlet tube falls into the collection vessel where is can be continuously, or more typically, periodically removed and, if necessary, treated to remove PFAS or other contaminants. Toward the bottom of the collector vessels there is preferably a valve leading to a drain to remove brine or a briny slurry that collects at the bottom of the collector vessel. Optionally, a pump assembly can be used to evacuate the contents of the collector vessel at high pressure during operation. In some preferred embodiments, a salt separator tube inlet 222 (carrying fluid into the collector tube) extends into the collector vessel by at least 5 cm or at least 10 cm (relative to the outlet into an upward flowing tube); this enhances downward flow of the saltier fraction into the bottom of the collector tube forcing the lighter fraction out of the outlet 224. The collector vessel(s) may contain baffles to minimize turbulence and mixing near the bottom of the collector vessel(s). Typically, conditions in the bottom of the collection vessel are subcritical.

The concentrated PFAS water 112 typically enters the salt separator at subcritical but preferably near supercritical conditions so that the salt is completely dissolved in the water allowing greater residence time for salt to fall out of solution and fall into the collection vessel. Alternatively, the water 112 can enter the salt separator at supercritical conditions. In the salt separator temperature is increased so that the solution becomes supercritical and sodium chloride and other salts precipitate from solution. Conditions (typically temperature) in successive zones of the salt separator can be controlled so that the salt becomes increasingly insoluble as it travels through the salt separator. In some embodiments, the solution entering the salt separator can be below 370° C. and increased in the range of 375 to 450° C. in the salt separator. Optionally, a fuel, such as an alcohol, could be added prior to or during the salt separation stage in order to increase temperature.

Water can pass through a heat exchanger 118 and then is typically combined with an oxidant 120, such as hydrogen peroxide, prior to introduction into SCWO reactor 144 where any remaining PFAS is destroyed. Although in the figure provided, peroxide (or other oxidant) to be added is introduced immediately before the reactor, there is the option to add the oxidant at various locations, including upstream of the salt separator. The advantages of adding oxidant in a plurality of locations include 1) minimizing the potential for a hot spot at the location where the peroxide is added, and 2) facilitating destruction of PFAS in the salt separator. However, a disadvantage of adding peroxide upstream of the salt separators is that corrosion can be exacerbated. The PFAS-free effluent can be passed through heat exchanger(s) such as 118, 114 to recover heat and then stored or passed out of the system as PFAS-free effluent 124.

The clean effluent preferably passes back through the second and first heat exchangers. At any point after the SCWO reactor, the cleaned water is preferably neutralized, such as by addition of sodium hydroxide. Also, if necessary, the cleaned water can be treated (for example to remove Cr or other metals) prior to disposal or return to the environment.

### EXAMPLES

The following example is the application of the method to a surface-active foam fractionate (SAFF). Acetic Acid was added to landfill leachate to lower the pH value to remove the alkalinity from the SAFF.
1. In a beaker add 2 liters of landfill leachate. Start adding glacial acetic acid 10 mL at a time, stirring after each addition. Record how many additions were needed and what the pH was after each condition.
2. Continue to add acetic acid until the pH is below 4.5 (i.e., 4.4 or less).
3. Allow the solution to sit for 60 minutes before processing further.

The experimental data (Table 1) indicates a significant reduction in not only alkalinity but also in silica content. Aeration was used in an attempt to promote the exhaustion of carbon dioxide, but results indicated that the use of aeration did not change the results. Alkalinity levels were expected to drop but not this significantly (>99%). The reduction of silica content was also unexpected. This step allows for the acidification of the leachate leading to carbonate species to react with the acidic species and create carbon dioxide which leaves the system by exhausting itself.

TABLE 1

| | | | Treated with | | Treated with | |
|---|---|---|---|---|---|---|
| | | Treated with | Acetic Acid | | Citric Acid and | |
| | Feed from | Acetic Acid | and then no | Treated with | then no | |
| | HCC | and then | aeration | Citric Acid and | aeration | |
| | LL-HCC- | aerated | LL-AA- | then aerated | LL-CA- | |
| Analyte | AerationFeed | LL-AA-AER | NoAER | LL-CA-AER | NoAER | Units |
| Alkalinity, Bicarbonate | 8220 | <10.0 | <10.0 | 38.0 | <10.0 | mg/L |
| (As CaCO3) | | | | | | |
| Alkalinity, Carbonate | 1160 | <10.0 | <10.0 | <10.0 | <10.0 | mg/L |
| (As CaCO3) | | | | | | |
| Alkalinity, Hydroxide | <10.0 | <10.0 | <10.0 | <10.0 | <10.0 | mg/L |
| (As CaCO3) | | | | | | |
| Alkalinity, Hydroxide | 9380 | <10.0 | <10.0 | 38.0 | <10.0 | mg/L |
| (As CaCO3) | | | | | | |
| Calcium | c | 48.4 | 43.4 | 49.9 | 59.3 | mg/L |
| Chloride | 2640 | 2310 | 2310 | 2570 | 2570 | mg/L |
| Fluoride | <10.0 | <10.0 | <10.0 | <10.0 | <10.0 | mg/L |
| Magnesium | 148 | 141 | 140 | 151 | 163 | mg/L |
| Silica, Dissolved (as | 437 | 247 | 239 | 250 | 155 | mg/L |
| SiO2) | | | | | | |
| Sodium | 2120 | 2010 | 2000 | 2120 | 2060 | mg/L |
| Total Dissolved Solids | 10000 | 10500 | 10800 | 21000 | 24600 | mg/L |
| (Residue, Filterable) | | | | | | |
| % Removal of Total | | 99.89% | 99.89% | 99.59% | 99.89% | |
| Alkalinity | | | | | | |
| % Removal of Silica | | 43.48% | 45.31% | 42.79% | 64.53% | |

### Contemplated Examples

### MgOx+Acidification:

These instructions are hypothetical for a scaled-up process to remove silica and alkalinity from raw SAFF (landfill leachate).
1. Fill vessel with SAFF to desired amount.
2. Start mixing and heating to 65-75° C.
3. Once temperature reaches the desired range, add MgOx at a quantity of 21 g MgOx per 1 liter of SAFF. Take pH measurements immediately before MgOx addition and every 30 minutes for 2 hours.
4. After 2 hours, if the mixture has a pH greater than 10.5, stop mixing and heating and allow the precipitant to settle. If pH is less than 10.5, add MgOx until pH reaches 10.5 and mix for another 30 minutes. After the 30 additional minutes, stop mixing and heating and allow the precipitant to settle.
5. After sufficient settling and cooling (approximately 2-3 hours), decant the effluent into another vessel for further processing.
6. Start mixing the effluent. Add glacial acetic acid to the effluent until pH is below 4.5. There will be vapor produced from this process and will have to be collected through vent hoods.
7. Mix the material for 2 hours and then allow to sit for 30 minutes. This can be fed directly to the SCWO Reactor.

### Acidification Without Precipitation Step:

These instructions are contemplated for a scaled-up process to remove alkalinity from raw SAFF (landfill leachate). Note, there should be no precipitant in this process.
1. Fill vessel with SAFF to desired amount.
2. Start mixing the SAFF. Add glacial acetic acid to the effluent until pH is below 4.5. There will be vapor produced from this process and can be collected through vent hoods.
3. Mix the material for 2 hours and then allow to sit for 30 minutes. This can be fed directly to the SCWO Reactor.

1. A method of purifying contaminated water, comprising:
providing contaminated water comprising an organic contaminant and a soluble inorganic species;
combining the contaminated water with an organic acid to form a treated water composition having a pH of 4.5 or less, preferably between 2 and 4.4; and, subsequently,
subjecting the treated water composition to further treatment comprising a hydrothermal treatment or a SCWO treatment;
wherein at least 90% of the organic contaminant is destroyed.

2. The method of claim 1 combining the contaminated water with an organic acid to form a treated water composition having a pH of 4.0 or less or 3.5 or less, or between 2.0 and 4.0.

3. The method of claim 1 further comprising a step following the combining step of filtering a precipitate.

4. The method of claim 1 comprising heating the treated water composition to a temperature of at least 50° C. or 50 to 90° C. or 70 to 80° C.

5. The method of claim 1 wherein the contaminated water comprises a carbonate species and the addition of organic acid causes the release of carbon dioxide from the carbonate species.

6. The method of claim 1 wherein the water comprising an organic contaminant is subjected to reverse osmosis to increase the concentration of the organic contaminant.

7. The method of claim 1 wherein the further treatment comprises SCWO with hydrogen peroxide or dioxygen.

8. The method of claim 1 wherein the organic contaminant comprises PFAS.

9. The method of claim 1 wherein the organic acid comprises 90 mass %, 95 mass %, or 99 mass % acetic acid.

10. The method of claim 1 wherein the method does not add a metal, silica and/or an alkaline earth element.

11. The method of claim 1 wherein the method does not add a precipitating agent.

12. The method of claim 1 further comprising a step combining the contaminated water comprising an organic contaminant and a soluble inorganic species with a precipitating agent that reacts with the soluble inorganic species to form a solid that precipitates out of solution to produce a precipitate and a first treated water solution in a clarifier;
combining treated water from the clarifier with the organic acid to form the treated water composition having a pH of 4.5 or less, preferably between 2 and 4.4.

13. The method of claim 12 further comprising: extracting the organic contaminant from the precipitate and combining the extracted contaminant with the treated water prior to the hydrothermal treatment or SCWO treatment.

14. The method of claim 1 wherein the soluble inorganic species comprise one or more of calcium, magnesium, phosphate, and silica.

15. The method of claim 1 wherein the soluble inorganic species comprise calcium or magnesium or both calcium and magnesium.

16. The method of claim 12 wherein the precipitating agent comprises lime, magnesium oxide, caustic (NaOH), aluminum sulfate, soda ash and/or sulfide precipitation reagents.

17. The method of claim 1 further comprising a step of adjusting pH prior to the step of adding a precipitating agent.

18. The method of claim 1 wherein the organic contaminant comprises PFAS and comprising:
adding a flow of the organic acid to a stream of PFAS-containing water to form an aqueous solution of the organic acid and PFAS;
wherein the average residence time of the fluid in the system, from the location of adding the flow of the organic acid to an inlet of the SCWO reactor is 3 minutes or less, preferably 1 minute or less, preferably 30 seconds or less; and
wherein the PFAS is destroyed in the SCWO reactor in a continuous process.

19. The method of claim 18 where the location is at or within 25 cm (or within 5 cm) of a pump that pushes the PFAS-containing water into a conduit that leads to a first heat exchanger in the system.

20. The method of claim 1 wherein the organic acid is added at a volume/volume ratio with contaminated water of between 1/1000 and 1/50 or 1/1000 to 1/100 or at least 5/1000 or at least 10/1000.

21. A system comprising: a sedimentation tank comprising water composition having a pH between 2 and 5 and comprising an organic contaminant and an organic acid;
a conduit connecting an outlet of the sedimentation tank to a hydrothermal or SCWO reactor;
optionally, additional components disposed between the sedimentation tank and the hydrothermal or SCWO reactor.

22-24. (canceled)

25. A method of destroying a contaminant by SCWO, comprising:
providing water comprising an organic contaminant and a scaling constituent;
adding to the water a precipitating agent that reacts with the scaling constituent to form a solid that precipitates out of solution to produce a precipitate and a first treated water solution;
separating the precipitate from the first treated water solution; and
subjecting the first treated water solution to a step of SCWO.

26-33. (canceled)
